(19) United States
(12) Patent Application Publication
(10) Pub. No.: US 2006/0139355 A1
(43) Pub. Date: Jun. 29, 2006

(54) Physically based motion retargeting filter

(76) Inventors: Seyoon Tak, Seoul (KR); Hyeong-Seok Ko, Seoul (KR)

Correspondence Address: PARK LAW FIRM, 3255 WILSHIRE BLVD, SUITE 1110, LOS ANGELES, CA, 90010, US

(21) Appl. No.: 11/317,844

(22) Filed: Dec. 23, 2005

Related U.S. Application Data
(60) Provisional application No. 60/639,393, filed on Dec. 27, 2004.

(51) Int. Cl. G06T 15/70

(52) U.S. Cl. 345/473

(57) ABSTRACT

A method for editing motion of a character includes steps of a) providing an input motion of the character sequentially along with a set of kinematic and dynamic constraints, wherein the input motion is provided by a captured or animated motion; b) applying a series of plurality of unscented Kalman filters for solving the contraints; c) processing the output from the unscented Kalman filters with a least-squares filter for rectifying the output; and d) producing a stream of output motion frames at a stable interactive rate. The steps are applied to each frame of the input motion The method may further include a step of controlling the behavior of the filters by tuning parameters and a step of providing a rough sketch for the filters to produce a desired motion. The Kalman filter includes per-frame Kalman filter. The least-squares filter is applied only to recently processed frames

### RELATED APPLICATION

This application is a corresponding non-provisional application of U.S. Provisional Patent Application Ser. No. 60/639,393 for “Physically Based Motion Retargeting Filter” filed on Dec. 27, 2004.

### BACKGROUND OF THE INVENTION

The present invention relates to a method for editing motion of a character.

More particularly, this invention relates to a method for editing motion of a character in a stable interactive rate.

1. Introduction

Motion editing is an active research problem in computer animation. Its function is to convert the motion of a source subject or character into a new motion of a target character while satisfying a given set of kinematic and dynamic constraints, as shown schematically in FIG. 1. This type of motion editing, in which the animator species what they want in the form of constraints, is called constraint-based motion editing, and has been studied by numerous researchers [Gleicher 1998; Lee and Shin 1999; Choi and Ko 2000; Popovic and Witkin 1999; Shin et al. 2001].

Motion editing must compensate for both body differences and motion differences. When the anthropometric scale of the target character differs from that of the source character, the original motion should be kinematically retargeted to the new character. Characteristics that affect body dynamics such as segment weights and joint strengths should be accounted for if we are to generate a dynamically plausible motion of the target character. For example, the kicking motion of a professional soccer player cannot be reproduced by an unskilled person of equivalent anthropometric characteristics. Therefore the motion editing algorithm should resolve both the kinematic and dynamic aspects of the source-to-target body differences. In addition, motion editing should provide means to create variations from the original motion. For example, starting from an original walking motion on a level surface, an animator may need to create longer steps or uphill steps.

This invention proposes a novel constraint-based motion editing technique that differs significantly from existing methods in that it is a per-frame algorithm. The traditionally employed spacetime optimization methods can be used for interactive editing of short motion sequences and produce physically plausible motions. However, the processing times of these methods increase proportional (or at a higher rate) to the length of the motion sequence. In contrast, our algorithm functions as a filter of the original motion that processes the sequence of frames in a pipeline fashion. Thus, the animator can view the processed frames at a stable interactive rate as soon as the filter has started processing the motion, rather than having to wait for all frames to be processed as is the case in spacetime optimization methods.

The per-frame approach has previously been taken by several researchers for the kinematic motion editing problem in which only kinematic constraints are imposed [Lee and Shin 1999; Choi and Ko 2000; Shin et al. 2001]. However, the problem of motion editing with both kinematic and dynamic constraints poses two significant challenges: (1) Dynamic constraints are highly nonlinear compared to kinematic constraints. Such nonlinearity prohibits the constraint solver from reaching a convergent solution within a reasonable amount of time. (2) Dynamic constraints involve velocities and accelerations, whereas kinematic constraints involve only positions. It is this significant distinction that makes the per-frame approach inherently difficult for dynamic constraints; kinematic constraints can be independently formulated for individual frames, whereas the velocity and acceleration terms in the dynamic constraint equations call for knowledge of quantities from other frames. The inter-dependency between those terms makes the process look like a chain reaction, whereby imposing dynamic constraints at a single frame calls for the participation of the positions and velocities of the entire motion sequence.

We overcome the challenges outlined above by casting the motion editing problem as a constrained state estimation problem based on the Kalman filter framework. We make the method function as a per-frame filter by incorporating the motion parameters and the desired constraints into a specialized Kalman filter formulation. To handle the nonlinearity of complex constraints more accurately, we employ the unscented Kalman filter, which is reported [Wan and van der Merwe 2001] to be superior in its accuracy to the other variants of the Kalman filter or the Jacobian-based approximation.

To apply Kalman filtering to the problem of motion editing, however, we must treat the position, velocity, and acceleration as independent degrees of freedom (DOFs). Under this treatment, the resulting motion parameter values may violate the relationship that exists between the position, velocity, and acceleration values describing a particular motion. We resolve this problem by processing the Kalman filter output with a least-squares curve fitting technique. We refer to this processing as the least-squares filter. Unlike the Kalman filter that processes each frame independently, the least-squares filter requires data over a certain range of frames for curve fitting.

Therefore, the proposed motion editing filter is basically a concatenation of the Kalman filter and the least-squares filter. It functions as an enhancement operator; the first application of the filter may not produce a completely convergent solution, but repeated applications refine the result until a reasonable solution is reached. Such incremental refinement can be valuable in practice, because most animators prefer to see a rough outline of the motion interactively before carrying out the longer calculation necessary to obtain the final motion. Furthermore, they can provide a rough sketch of the desired motion before the filtering begins, which is an effective way of reflecting their intuitive ideas as well as overcoming the locality nature of the proposed algorithm.

Our motion editing technique is well suited for interactive applications; we can add or remove some or all of the kinematic and dynamic constraints depending on whether they significantly affect the type of motion being animated. When only kinematic constraints are imposed, one application of the filter produces a convergent solution and the motion editing algorithm runs in real-time. As dynamic constraints are added, the filter must be applied several times to obtain convergent results, but the editing process still runs at an interactive speed.

2. Related Work

The establishment of motion capture as a commonplace technique has heightened interest in methods for modifying or retargeting a captured motion to different characters. Motion editing/synthesizing methods can be classified into four groups: (1) methods that involve only kinematic constraints, (2) methods that involve both kinematic and dynamic constraints, (3) the spacetime constraints methods that do not exploit the captured motion, and (4) motion generating techniques based on dynamic simulation.

Gleicher [1997; 1998] formulated the kinematic version of the motion editing problem as a spacetime optimization over the entire motion. Lee and Shin [1999] decomposed the problem into per-frame inverse kinematics followed by curve fitting for motion smoothness. Choi and Ko [2000] developed a retargeting algorithm that works on-line, which is based on the per-frame inverse rate control but avoids discontinuities by imposing motion similarity as a secondary task. Shin et al. [2001] proposed a different on-line retargeting algorithm based on the dynamic importance of the end-effectors. A good survey of the constraint-based motion editing methods is provided by Gleicher [2001]. The way our motion editing technique works most resembles the approach of [Lee and Shin 1999], in that both techniques are per-frame methods with a post-filter operation. However, in our method, the post-filter is applied only to recently processed frames and, as a consequence, the whole process works as a per-frame filter.

It is interesting to note that the methods based on kinematic constraints quite effectively generate useful variations of the original motion. However, when the dynamic context is significantly different in the source and target motions, the motion generated by kinematic editing is unacceptable. Pollard et al. [2000] proposed a force-scaling technique for fast motion transformation. Tak et al. [2000] introduced a spacetime optimization technique for correcting a given motion into a dynamically balanced one. Popovic and Witkin [1999] addressed the physically based motion editing problem using spacetime optimization. Because optimization subject to dynamic constraints (i.e. Newton's law) can take a prohibitive amount of computation, they introduced a character simplification technique to make the problem tractable. The most significant distinction between our method and spacetime optimization methods is that, instead of looking at the entire duration of a motion, our technique works on a per-frame basis. As a result, the outcome of each frame is available at a uniform interactive rate, since it requires a deterministic amount of computation.

An interesting work that solves the retargeting problem in the robotics context is [Yamane and Nakamura 2000; 2003], which is similar to our approach in that it transforms a given motion into a physically consistent one on a per-frame basis. Their dynamics filter first computes the desired accelerations by feedback controllers referring to the reference motion, and then modifies the result by projection to the null-space of the equation of motion to make it dynamically consistent one. Our approach differs from theirs in that we use an iterative algorithm that consists of two consecutive filters and we process position, velocity, and acceleration simultaneously rather than acceleration alone, thus increasing the applicability. For the same reason, it is difficult to control kinematic constraints in their method, since they deal with only accelerations in the filtering process and then integrate them to obtain the final positional data. Also, as they pointed out in the invention, the sensitiveness to the reference motion which causes filter divergence and the difficulty of tuning parameter (feedback gains, pseudoinverse weights) are unsolved problems. Another recent work similar to ours is [Shin et al. 2003], which improves physical plausibility of edited motions by enforcing ZMP constraints and momentum constraints. While our method is an iterative filtering process over all DOFs, they sequentially adjusted user-specified individual DOF using approximated closed-form dynamic equations for efficiency.

Many of the kinematic and physically based motion editing techniques mentioned above derive from the spacetime constraints method proposed by Witkin and Kass [1988]. However, when this original method is applied to a complex articulated figure, the dimensional explosion and severe nonlinearity of the problem usually leads to impractical computational loads or lack of convergence. Several groups [Cohen 1992; Liu et al. 1994; Rose et al. 1996] have attempted to improve the classical spacetime constraints algorithm and its applicability. In a recent work that synthesizes a dynamic motion from a rough sketch, [Liu and Popovic 2002] circumvented the problems by approximating the Newtonian dynamics with linear and angular momentum patterns during the motion. Another optimization based motion synthesis algorithm was proposed by [Fang and Pollard 2003], which showed a linear-time performance.

Our constraint solver is built on the Kalman filter framework. There have been several previous attempts to treat constraints using the Kalman filter. Maybeck [1979] introduced the notion that the Kalman filter can be used to solve linear constraints by regarding them as perfect measurements, while other workers [Geeter et al. 1997; Simon and Chia 2002] built constraint solvers based on the extended Kalman filter to solve nonlinear constraints. However, as many researchers have pointed out [Julier and Uhlmann 1997; Wan and van der Merwe 2000], the extended Kalman filter can produce inaccurate results at nonlinearities. We used the unscented Kalman filter to better handle the severe nonlinearities in the dynamic constraints. A good introduction to the Kalman filter can be found in [Welch and Bishop 2001].

The preliminary version of this work was presented in [Tak et al. 2002]. In the current article, we give a significantly improved exposition of the technique as well as extend the technique; The formulation is now more rigorous, and the method is compared with other methods so that its limitations and strengths are highlighted. By addressing momentum conservation in the flight phases and the redundancy problem during the double support phases, we widen the applicability of the algorithm. New experiments that show the extended features are reported.

Accordingly, a need for a physically based motion retargeting filter has been present for a long time. This invention is directed to solve these problems and satisfy the long-felt need.

### SUMMARY OF THE INVENTION

The present invention contrives to solve the disadvantages of the prior art.

An objective of the invention is to provide a method for editing motion of a character.

Another objective of the invention is to provide a method for editing motion of a character in a stable interactive rate.

Still another objective of the invention is to provide a method for editing motion of a character in which the animators can interactively control the type and amount of kinematic and dynamic constraints to shape the desired motion.

A method for editing motion of a character includes steps of a) providing an input motion (source character) of the character sequentially along with a set of kinematic and dynamic constraints, and the input motion is provided by a captured or animated motion; b) applying a series of plurality of unscented Kalman filters for solving the contraints; c) processing the output from the unscented Kalman filters with a least-squares filter for rectifying the output; and d) producing a stream of output motion (target character) frames at a stable interactive rate. The steps are applied to each frame of the input motion

The method may further include a step of controlling the behavior of the filters by tuning parameters according to different motions and a step of providing a rough sketch (kinematic hint) for the filters to produce a desired motion.

The Kalman filter includes per-frame Kalman filter. The least-squares filter is applied only to recently processed frames.

The method may further include a step of retargeting the motion of character kinematically.

The method may further include steps of a) providing motion parameters and desired constraints to the filters; b) resolving the kinematic and dynamic aspects of the source-to-target body differences; and c) creating variations from the original motion. The motion parameters include the position, velocity, and acceleration.

The Kalman filter handles the position, velocity, and acceleration as independent degrees of freedom. The number of Kalman filter is determined by the quality of output motion. The number of Kalman filter can one (1) for the kinematic constraints only.

The kinematic and dynamic constraints include kinematic constraints, balance constraints, and torque limit constraints, momentum constraints.

The character include a plurality of end-effectors to represent and control the spatial extension of the character, and the end-effectors are positioned by the kinematic constraints.

The kinematic constraints are represented by a component constraint function H_{K}, where H_{K} is formulated as H_{K}(q, \dot{q}, \ddot{q})=h_{fk}(q), where h_{fk}(q)=e is a forward kinematic equation, where e is a desired locations and q is a vector that completely describes the kinematic configuration of the character at a certain time.

The balance constraints is for the net moment of inertial forces and gravitational forces of all the body component at a zero moment point (ZMP) to be located inside the supporting area (S), where the supporting area is a convex hull containing all the ground contacts.

The moment of inertial forces and gravitational forces at the zero moment point is obtained by solving the equation for

$${P}_{zmp ,} {\sum }_{i} [ ( {r}_{i} - {P}_{zmp} ) \times \{ {m}_{i} ( {\ddot{r}}_{i} - g ) \} ] = 0 ,$$

where mᵢ and rᵢ are the mass and center of mass of the i-th segment of the body and g is the gravitation of gravity. The balance of the character is achieved by modifying the motion parameters including position, velocity, and acceleration such that the moment of inertial forces and gravitational forces at the zero moment point gets back to the area S.

The balance constraints are imposed by calculating the torque profile of the original motion and reducing the torque to the predetermined limit if the torque exceeds a predetermined limit.

The momentum constraints are imposed by making the change of the linear and angular momenta equal to the sums of the resultant forces and moments acting on the character. The momentum constraints are imposed only in flight phases, not in supporting phases.

The unscented Kalman filter uses a deterministic sampling method that approximates the posterior mean and covariance from the transformed results of a fixed number of samples.

The deterministic sampling method for a given nonlinear function h(x)=z defined for n-dimensional state vector x includes steps of: a) choosing 2n+1 sample points that convey the prior state distribution (mean and covariance of x); b) evaluating the nonlinear function h at these points; c) producing the transformed sample points; and d) approximating the posterior mean and covariance by calculating the weighted mean and covariance of the transformed sample points.

The Kalman filter includes a per-frame Kalman filter, and the least-squares filter rectified any corruption of the relationship among the independent variables; position, velocity, and acceleration. The least-squares filter smoothes out the jerkiness introduced by the per-time handling of the motion data.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a conceptual diagram of the constraint-based motion editing problem;

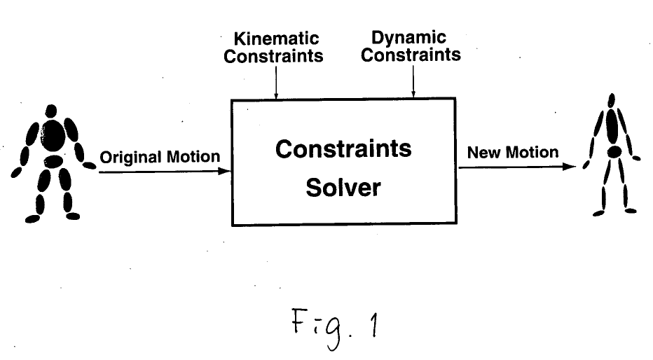

FIG. 2 is a schematic diagram of overall structure of the motion editing process;

FIG. 3 is a schematic diagram showing the zero moment point and its trajectory correction;

FIG. 4 is a diagram showing comparison of mean and covariance approximations after the nonlinear transformation is applied;

FIG. 5 is diagram showing sweeping of the Kalman filter and the least-squares filter;

FIG. 6 is snapshots showing a dancing;

FIG. 7 is snapshots showing wide steps;

FIG. 8 is snapshots showing a golf swing;

FIG. 9 is snapshots showing a limbo walk;

FIG. 10 is snapshots showing a jump kick.

### DETAILED DESCRIPTION OF THE INVENTION

The U.S. Provisional Patent Application Ser. No. 60/639,393 filed on Dec. 27, 2004 and the paper, ACM Transactions on Graphics, Volume 24, No. 1 (January 2005), pp. 98-117, by the applicants are incorporated by reference into this disclosure as if fully set forth herein.

3. Overview

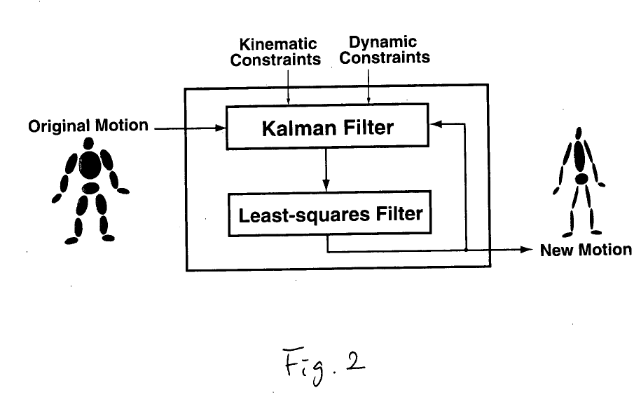

FIG. 2 shows an outline of the overall structure of our motion editing process. Animators first provide the input motion of the source character along with a set of kinematic and dynamic constraints. Then a Kalman filter that is tailored to the motion editing problem produces the motion parameter values, which are post-processed by the least-squares curve fitting module. We apply the Kalman filter and least-squares filter repeatedly until it converges to an acceptable result. Several important issues must be addressed in the implementation of the process outlined above:

What kinds of constraints are needed to generate a desired motion? How should those constraints be formulated? These issues are addressed in Section 4.

How is the Kalman filter applied to our motion editing problem? The details are presented in Section 5.

The Kalman filter processes position, velocity, and acceleration as independent variables, which can corrupt the imperative relationship among those variables. How is this rectified by the least-squares filter? This is explained in Section 6.

4. Formulating Constraints

The collection of all the kinematic and dynamic constraints on the motion of a character with Λ DOFs can be summarized into the form
H(q, \dot{q}, \ddot{q})=Z, (1)
where q=q(t) is the Λ-dimensional vector that completely describes the kinematic configuration of the character at time t. This vector contains a mixture of positional and orientational quantities, but when it is clear from the context, we call the entire vector simply the position.

The vector valued function H:R^{3Λ}→R^{\tilde{Λ}} that maps a 3Λ-dimensional vector to a \tilde{Λ}=\tilde{Λ}_{K}+\tilde{Λ}_{B}+\tilde{Λ}_{T}+\tilde{Λ}_{M} dimensional vector can be written as

$$H ( q , \dot{q} , \ddot{q} ) = [ \begin{matrix}{H}_{K} ( q , \dot{q} , \ddot{q} ) \\ {H}_{B} ( q , \dot{q} , \ddot{q} ) \\ {H}_{T} ( q , \dot{q} , \ddot{q} ) \\ {H}_{M} ( q , \dot{q} , \ddot{q} )\end{matrix} ] . \qquad ( 2 )$$

\tilde{Λ}_{K}, \tilde{Λ}_{B}, \tilde{Λ}_{T}, and \tilde{Λ}_{M} are the dimensions of the kinematic, balance, torque limit, and momentum constraints, respectively. Therefore we can view the function H as a block matrix of the component constraint functions H_{K}, H_{B}, H_{T}, and H_{M}, as shown in the right-hand side of Equation (2). The values of \tilde{Λ}_{K}, \tilde{Λ}_{B}, \tilde{Λ}_{T}, and \tilde{Λ}_{M} depend on how each type of constraint participates in the current editing process. For example, when only one end-effector position constraint is imposed, \tilde{Λ}_{K}=3. If an additional orientational constraint is imposed, then \tilde{Λ}_{K} becomes 6. Z is a Λ-dimensional vector that does not contain any variables, and can be represented as the block matrix Z=[Z_{K}^{T} Z_{B}^{T} Z_{T}^{T} Z_{M}^{T}]^{T}. The goals of this section are (1) to find the formulations for each of the component constraint functions H_{K}, H_{B}, H_{T}, and H_{M}, and (2) to find the values for the component constraint goals Z_{K}, Z_{B}, Z_{T}, and Z_{M}, which correspond to the constraints specified by the animators.

The constraint solver this invention proposes requires only the formulation of the component functions, but does not require their derivatives or inverse functions. Constraints are resolved by the black box composed of the Kalman filter and least-squares filter.

4.1 Kinematic Constraints

Kinematic constraints specify the end-effectors to be positioned at the desired locations e by
h_{fk}(q)=e, (3)
where the function h_{fk} is the forward kinematic equations for the end-effectors under consideration. Therefore, H_{K} is simply formulated as
H_{K}(q, \dot{q}, \ddot{q})=h_{fk}(q), (4)
and the constraint goal is given by Z_{K}=e.
4.2 Balance Constraints

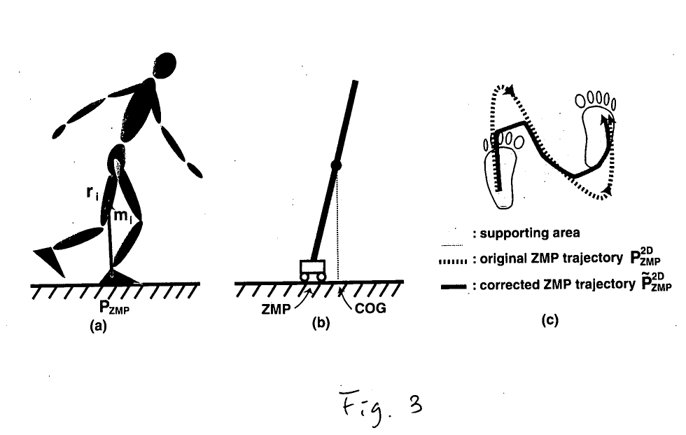

Because humans are two-legged creatures, balancing is an important facet of their motion that must be adequately captured if an animation is to appear realistic. Dynamic balance is closely related to the zero moment point (ZMP), that is, the point at which the net moment of the inertial forces and gravitational forces of all the body segments is zero [Vukobratovic et al. 1990]. The ZMP at a particular instant is a function of the character motion, and can be obtained by solving the following equation for P_{zmp}

$${\sum }_{i} [ ( {r}_{i} - {P}_{zmp} ) \times \{ {m}_{i} ( {\ddot{r}}_{i} - g ) \} ] = 0 , \qquad ( 5 )$$

where mᵢ and rᵢ are the mass and center of mass of the ith segment (FIG. 3(a)), respectively, and g is the acceleration of gravity. In our work, we regard an animated motion to be dynamically balanced at time t if the projection P_{zmp}^{2D} of the ZMP is located inside the supporting area (the convex hull containing all the ground contacts). Taking rᵢ=(xᵢ, yᵢ, zᵢ), g=(0, −g(≈9.8), 0), and setting the y component of P_{zmp} to zero, Equation (5) produces the following analytical solution for P_{zmp}^{2D}:

$${P}_{zmp}^{2 D} = [ \begin{matrix}\frac{{\sum }_{i} {m}_{i} ( {\ddot{y}}_{i} + g ) {x}_{i} - {\sum }_{i} {m}_{i} {\ddot{x}}_{i} {y}_{i}}{{\sum }_{i} {m}_{i} ( {\ddot{y}}_{i} + g )} \\ \frac{{\sum }_{i} {m}_{i} ( {\ddot{y}}_{i} + g ) {z}_{i} - {\sum }_{i} {m}_{i} {\ddot{z}}_{i} {y}_{i}}{{\sum }_{i} {m}_{i} ( {\ddot{y}}_{i} + g )}\end{matrix} ] = {h}_{zmp} ( q , \dot{q} , \ddot{q} ) . \qquad ( 6 )$$

Since rᵢ and \ddot{r}ᵢ can be expressed by q, \dot{q}, and \ddot{q}, we can view the above result as giving the formula for the function h_{zmp}(q, \dot{q}, \ddot{q}). Note that for a static posture, the ZMP in Equation (6) reduces to the center of gravity

$$( \frac{{\sum }_{i} {m}_{i} {x}_{i}}{{\sum }_{i} {m}_{i}} , \frac{{\sum }_{i} {m}_{i} {z}_{i}}{{\sum }_{i} {m}_{i}} ) ,$$

the projection point of the center of mass of the whole body on the ground. Some portions of P_{zmp}^{2D} obtained by evaluating the above formula may lie outside the supporting area as shown in FIG. 3(c). In our work, balancing is achieved by modifying the motion (i.e. q, \dot{q}, and \ddot{q}) such that h_{zmp}(q, \dot{q}, \ddot{q}) follows a new trajectory \tilde{P}_{zmp}^{2D} given by
\tilde{P}_{zmp}^{2D}(t)=P_{zmp}^{2D}(t): if P_{zmp}^{2D}(t)εS
\tilde{P}_{zmp}^{2D}(t)=projₛ(\tilde{P}_{zmp}^{2D}(t)): otherwise (7)
where S is the supporting area and projₛ is the operator that projects the given point into the area S as shown in FIG. 3(c). Finally, the balance constraint is formulated as
H_{B}(q, \dot{q}, \ddot{q})=h_{zmp}(q, \dot{q}, \ddot{q}) (8)
and Z_{B}=\tilde{P}_{zmp}^{2D}.

It should be noted that the notion of balance in this invention is somewhat subtle, and different from the usual meaning—not falling. A number of researchers in robotics and graphics have proposed balancing techniques. One approach, based on the inverted pendulum model, ensures balanced motion by maintaining the position and velocity of the center of gravity (COG) within a stable region [Faloutsos et al. 2001; Zordan and Hodgins 2002]. The same goal has also been achieved by tracking the ZMP trajectory as an index of stability [Dasgupta and Nakamura 1999; Oshita and Makinouchi 2001; Sugihara et al. 2002]. In these previous studies, balancing was achieved by controlling the joint torques to prevent the characters from falling. If our objective is to analyze the moment of a legged figure with respect to the ground, we can equivalently represent the figure as an inverted pendulum (FIG. 3(b)). In this conceptualization, the location of the pendulum base corresponds to the ZMP. In every realworld motion with a ground contact, even in falling motion, the ZMP always lies within the supporting area [Vukobratovic et al. 1990]. During flight phases, however, the evaluation of \tilde{P}_{zmp}^{2D} in Equation 6 results in dividing by zero, thus the ZMP is not defined. This is consistent with our intuition that balance is a meaningful concept only when the body makes contact with the ground. In flight phases, therefore, we deactivate the balance constraint. Detecting the initiation of the flight phase is done by examining the positions of the feet. The simulation results are insensitive to the noise at the phase boundaries. Physically, therefore, the ZMP is not related to the act of balancing. Rather, the ZMP concept is related to physical validness. Physical validness has no meaning in real world motions, but has a significant meaning in motion editing. We can judge that a computer-generated motion is out of balance if the motion is physically invalid according to the ZMP criterion. Our balance constraint formulation based on the ZMP provides an effective way to modify a given motion to achieve dynamic balance.

4.3 Torque Limit Constraints

The torque a human can exert at each joint is limited. However, computer-generated human motion can violate this principle, potentially giving rise to motions that look physically unrealistic or uncomfortable [Lee et al. 1990; Ko and Badler 1996; Komura et al. 1999]. To address this issue, we allow animators to specify torque limit constraints. The motion editing algorithm must therefore modify the given motion such that the joint torques of the new motion are within the animator-specified limits. We need to find the formulation of the function H_{T}(q, \dot{q}, \ddot{q}) and the goal Z_{T} that achieves the modification.

First, we must calculate the torque profile of the original motion to see if it contains any torque limit violations. We let τ(t)=[τ₁(t) . . . τ_{Λ-6}(t)]^{T} be the torque vector at time t, which is the collection of the scalar torques corresponding to the (Λ−6) joint DOFs. The inverse dynamics problem τ(t)=h_{trq}(q, \dot{q}, \ddot{q}) has been extensively studied in the robotics literature [Craig 1989; Shabana 1994]. Here we use the O(L) Newton-Euler method, which does not give an explicit formula for h_{trq}(q, \dot{q}, \ddot{q}), but instead recursively computes the torque values. For the closed-loop formed during the double support phases, we resort to the approximation method proposed by [Ko and Badler 1996].

When the torque τⱼ(t) computed as described above exceeds the specified limit τⱼ^{max}, we reduce it to the given limit. Thus, the corrected torque profile \tilde{τ}ⱼ of joint j is given by
\tilde{τ}ⱼ(t)=τⱼ(t): if τⱼ(t)≦τⱼ^{max}
\tilde{τ}ⱼ(t)=τⱼ^{max}: otherwise (9)
In our implementation, the torque limit τⱼ^{max} was given by animators experimentally, but can also be determined using joint strength data from the biomechanics [Winter 1990].

Finally, the torque constraints are formulated as
H_{T}(q, \dot{q}, \ddot{q})=h_{trq}(q, \dot{q}, \ddot{q}), (10)
with Z_{T}=\tilde{τ}.
4.4 Momentum Constraints

The momentum constraints are derived from Newton's second law, which states that the rates of change of the linear and angular momenta are equal to the sums of the resultant forces and moments acting on the figure, respectively. In the supporting phases, the interaction between the feet and the ground leads to quite complex patterns in the character's momentum behavior. Therefore, we do not impose momentum constraints in the supporting phases. In flight phases, however, gravity is the only external force. Thus the linear momentum and the net angular momentum of the entire body must satisfy \dot{P}=mₐₗₗ\ddot{c}=mₐₗₗg and \dot{L}=Σᵢmᵢ(rᵢ−c)×(\ddot{r}ᵢ−\ddot{c})=0 (point mass model assumed), where mall is the total mass and c is the center of mass of the entire figure [Liu and Popovic 2002]. Hence, we formulate the momentum constraints during flight phases as

$${H}_{M} ( q , \dot{q} , \ddot{q} ) = [ \begin{matrix} \ddot{c} - g \\ {\sum }_{i} {m}_{i} ( {r}_{i} - c ) \times ( {\ddot{r}}_{i} - \ddot{c} )\end{matrix} ] , \qquad ( 11 )$$

with Z_{T}=0 in this case.
5. Kalman Filter-Based Motion Editing

Once the constraints are formulated as shown in Equation (1), the task of modifying the original motion to meet the constraints is accomplished using Kalman filtering. The important decisions in our tailoring of Kalman filtering to motion editing problem are (1) the choices for the process and measurement model, and (2) using the unscented Kalman filter rather than the extended Kalman filter. We begin this section with a brief explanation of how Kalman filtering works. Then we show how the motion editing problem is formulated in the framework of Kalman filtering.

5.1 How Kalman Filtering Works

Kalman filtering is the problem of sequentially estimating the states of a system from a set of measurement data available on-line [Maybeck 1979; Welch and Bishop 2001]. The behavior of a Kalman filter is largely determined by defining the process model xₖ₊₁=f(xₖ,vₖ) and the measurement model zₖ=h(xₖ,vₖ), where xₖ represents the state of the system at time tₖ, zₖ is the observed measurement, and vₖ and nₖ are the process and measurement noise. For example, if we are to model the freefall of a stone that is being recorded by a digital camera, xₖ is the random variable that represents the 3D position of the stone, Pₓₖ (which will appear in the subsequent descriptions) is the covariance of xₖ, and zₖ represents the 2D position of the stone recorded in the photograph. We define the process model f so that it predicts the next state from the value of the current state (using knowledge of Newtonian mechanics). The uncertainties due to factors such as air resistance and wind are modeled by vₖ, which is assumed to follow a Gaussian distribution. We define the measurement model h such that it describes in principle the relationship between the state xₖ and the measurement zₖ. nₖ models the measurement errors, and is also assumed to follow a Gaussian distribution. The Kalman filter recursively estimates the mean and covariance of the state using the following predictor-corrector algorithm.

$$Predict ( time update ) Correct ( measurement update )$$

$${\hat{x}}_{k}^{-} = f ( {\hat{x}}_{k - 1}^{-} , 0 ) {\hat{x}}_{k} = {\hat{x}}_{k}^{-} + {K}_{k} ( {z}_{k} - h ( {\hat{x}}_{k}^{-} , 0 ) )$$

The time update predicts the a priori estimate \hat{x}ₖ⁻, and the measurement update corrects \hat{x}ₖ⁻ by referring to the new measurement zₖ to obtain the a posteriori estimate \hat{x}ₖ. The Kalman gain Kₖ is determined from the process and measurement models according to the procedure described in Section 5.3.
5.2 Our Formulation of Motion Editing Problem

When formulating the constraint-based motion editing problem using a Kalman filter, the most substantial step is the determination of the process and measurement models. We define the process model as \hat{x}ₖ⁻=[qₖ \dot{q}ₖ \ddot{q}ₖ], where qₖ=q(tₖ) is the value of q at the discrete time step tₖ. In this case, function f does not depend on the previous state \hat{x}ₖ₋₁⁻, but directly comes from the original motion. We use Z in Equation (1) as the measurements, and denote the value of Z at time tₖ as Zₖ. We define the measurement model as H(qₖ \dot{q}ₖ \ddot{q}ₖ) of Equation (1).

The rationale behind the definition outlined above is that the original motion contains excellent kinematic and dynamic motion quality, so by starting from this motion we intend to preserve its quality in the final motion.

5.3 Motion Editing Algorithm Based on the UKF

Since the constraint functions in Equation (2) are highly nonlinear, the original version of the Kalman filter, which was designed for linear systems, does not properly handle the motion editing problem considered here. The extended Kalman filter (EKF) was developed to handle nonlinearity through a Jacobian-based approximation, but recently the unscented Kalman filter (UKF) was proposed to better handle the severe nonlinearity.

The UKF was first proposed by Julier et al. [1997], and further developed by others [Wan and van der Merwe 2000; van der Merwe and Wan 2001]. The basic difference between the EKF and the UKF lies in the way they handle nonlinear functions. The computational core of the Kalman filter consists of the evaluation of the posterior mean and covariance when a distribution with the prior mean and covariance goes through the nonlinear functions of the process and the measurement models.

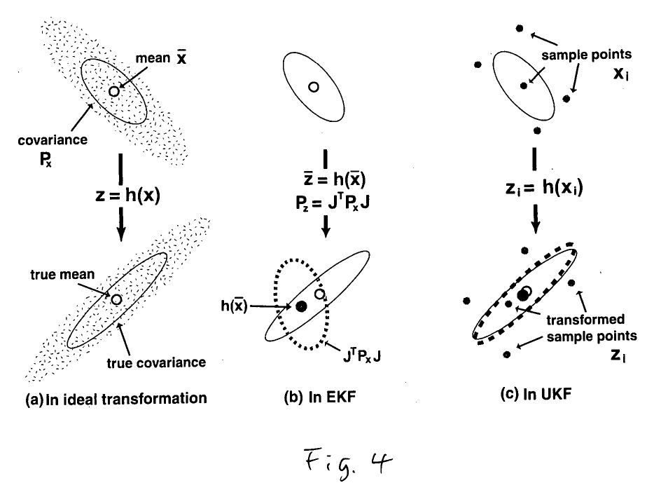

As shown in FIG. 4(b), the EKF approximates the posterior mean by evaluating the nonlinear function at the prior mean, and approximates the posterior covariance as the product of the Jacobian and the prior covariance. However, it has been reported that this method can lead to inaccuracy and occasional divergence of the filter [Julier and Uhlmann 1997; Wan and van der Merwe 2000].

The UKF addresses this problem using a deterministic sampling approach that approximates the posterior mean and covariance from the transformed results of a fixed number of samples as shown in FIG. 4(c). Given a nonlinear function h(x)=z defined for n dimensional state vectors x, the UKF first chooses 2n+1 sample points [symbol] ᵢ that convey the prior state distribution (mean and covariance of x), after which it evaluates the nonlinear function h at these points, producing the transformed sample points [symbol] ᵢ. The UKF then approximates the posterior mean and covariance by calculating the weighted mean and covariance (\hat{Z}ₖ⁻ and \hat{P}_{zz} in Step 4 of the procedure summarized below) of the transformed sample points, which is accurate to the 2nd order for any nonlinearity as opposed to the 1^{st} order in the EKF. The superior performance of the UKF over the EKF is well discussed in [Wan and van der Merwe 2001], along with the quantitative analysis on a broad class of nonlinear estimation problems.

Now, we summarize the steps involved in the proposed UKF-based constraint solver. The inputs fed into the solver at each frame k are the source motion [qₖ \dot{q}ₖ \ddot{q}ₖ] and the constraint goal Zₖ.

For each k th frame,
1. Using the process model definition discussed in Section 5.2, the prediction step is straightforward3:

$${\hat{x}}_{k}^{-} = [ {q}_{k} {\dot{q}}_{k} {\ddot{q}}_{k} ] \\ {\hat{P}}_{k}^{-} = [ \begin{matrix}{V}_{x . pos} … 0 \\ {V}_{x . vel} \\ 0 … {V}_{x . acc}\end{matrix} ] \qquad ( 12 )$$
where V_{x.*} are the process noise covariances. Since our process model is not defined in terms of the previous state, \hat{P}ₖ⁻ does not depend on \hat{P}ₖ₋₁⁻. Therefore we simply use the constant matrix shown above for every frame. The state vector and covariance matrix contain only positional components when only kinematic constraints are involved.
2. We construct (2n+1) sample points from \hat{x}ₖ⁻ and \hat{P}ₖ⁻ by [symbol]
   ₀=\hat{x}ₖ⁻ W₀=κ/(n+κ) i=0 [symbol]
   ᵢ=\hat{x}ₖ⁻+(\sqrt{(n+κ)\hat{P}ₖ⁻})ᵢ Wᵢ=1/{2(n+κ)} i=1, . . . , n [symbol]
   ᵢ=\hat{x}ₖ⁻−(\sqrt{(n+κ)\hat{P}ₖ⁻})ᵢ Wᵢ=1/{2(n+κ)} i=n+1, . . . , 2n (13)
where κ is a scaling parameter, (√)ᵢ signifies the ith row or column of the matrix square root, and Wᵢ is the weight associated with the ith sample point chosen such that Σᵢ₌₀²ⁿWᵢ=1. Our choice for κ is based on [Wan and van der Merwe 2001].
3. We transform the sample points in Step 2 through the measurement model defined in Section 5.2 to obtain [symbol]
   ᵢ=H( [symbol] ᵢ) i=0, . . . , 2n. (14)
4. The predicted measurement \hat{Z}ₖ⁻ is given by the weighted sum of the transformed sample points, and the innovation covariance and the cross covariance are computed as
   \hat{Z}ₖ⁻=Σᵢ₌₀²ⁿWᵢ [symbol] ᵢ
   \hat{P}_{zz}=Σᵢ₌₀²ⁿWᵢ( [symbol] ᵢ−\hat{Z}ₖ⁻)( [symbol] ᵢ−\hat{Z}ₖ⁻)^{T}+N_{z}
   \hat{P}_{xz}=Σᵢ₌₀²ⁿWᵢ( [symbol] ᵢ−\hat{x}ₖ⁻)( [symbol] ᵢ−\hat{Z}ₖ⁻)^{T}, (15)
where N_{z} is the measurement noise covariance.
5. The Kalman gain and the final state update are given by
   Kₖ=\hat{P}_{XZ}\hat{P}_{ZZ}⁻¹
   \hat{x}ₖ=\hat{x}ₖ⁻+Kₖ(Zₖ−\hat{Z}ₖ⁻). (16)
   The behavior of the filter can be controlled by adjusting the following parameters:

The process noise covariance V_{x,*}, which is a diagonal matrix. Each diagonal element of this matrix represents the degree of uncertainty of the corresponding DOF. The values of these diagonal elements are related to the degree of displacement that occurs in the filtering process. A larger value of a particular element results in a bigger displacement of the corresponding DOF.

The measurement noise covariance N_{z}, which is also a diagonal matrix. Each diagonal element is related to the rigidity of one of the constraints on the motion. Typically, these elements are set to zero, treating the constraints as perfect measurements. Using non-zero diagonal elements is useful when two constraints conflict with each other, because the constraint with the larger covariance (soft constraint) yields to the one with the smaller covariance (hard constraint).

6. Least-Squares Filter

The Kalman filter described in the previous section handles q, \dot{q}, and \ddot{q} as independent variables. As a result, the filtered result may not satisfy the relationship between the position, velocity, and acceleration. The role of the least-squares filter is to rectify any corruption of this relationship that occurred during Kalman filtering. If only kinematic constraints are involved, the least-squares filter need not be applied. However, even in this case, the animator may choose to apply the least-squares filter to eliminate potential artifacts arising from the use of a per-frame approach. Because the least-squares filter is basically a curve fitting procedure, it produces a tendency to smooth out the jerkiness that may be introduced by the per-frame handling of the motion data.

To find the control points (in 1D) that fit the complete profile \check{q} of a particular DOF, we formulate a B-spline curve that conforms to
Bc=q,

$$B = [ \begin{matrix}{B}_{1} ( {t}_{1} ) … {B}_{M} ( {t}_{1} ) \\ ⋮ \\ {B}_{1} ( {t}_{N} ) … {B}_{M} ( {t}_{N} ) \\ {\dot{B}}_{1} ( {t}_{1} ) … {\dot{B}}_{M} ( {t}_{1} ) \\ ⋮ \\ {\ddot{B}}_{1} ( {t}_{N} ) … {\ddot{B}}_{M} ( {t}_{N} )\end{matrix} ] , c = [ \begin{matrix}{c}_{1} \\ ⋮ \\ {c}_{M}\end{matrix} ] , \breve{ q} = [ \begin{matrix}{q}_{1} \\ ⋮ \\ \frac{{q}_{N}}{{\dot{q}}_{1}} \\ ⋮ \\ \frac{{\dot{q}}_{N}}{{\ddot{q}}_{1}} \\ ⋮ \\ {\ddot{q}}_{N}\end{matrix} ] \qquad ( 17 )$$

where Bᵢ(t), \dot{B}ᵢ(t), and \ddot{B}ᵢ(t) (i=1, . . . , M) are the B-spline basis functions and their first and second derivatives, respectively, and the scalar values cᵢ are the control points. For a 3 DOF joint, we need to formulate four such equations corresponding to the four components of the quaternion representation, and re-normalize the resulting values to maintain the unity of the quaternions. The spacing of the control points along the time axis can be determined by the user, possibly by considering the distribution of frequency components in the motion. In our experiments, we place a control point at every fourth frame in common cases, but when the smoothing artifact in high-frequency motions is visible, we place a control point at every second frame.

The above problem is that of an over-constrained linear system. Therefore, we find the control points c that best approximate the given data \check{q} by minimizing the weighted objective function
(Bc−\check{q})^{T}W(Bc−\check{q}), (18)
where W is a 3N×3N diagonal matrix that controls the relative influences of q, \dot{q}, and \ddot{q}.

The classical linear algebra solution to this problem is
c=(B^{T}WB)⁻¹W\check{q}=B^{#}\check{q}, (19)
where B¹⁹⁰ is the weighted pseudo-inverse matrix of B, and is easily computed because B^{T}WB is a well-conditioned matrix. Finally, we obtain the least-squares filtered motion by evaluating the B-spline curves at the discrete time steps.

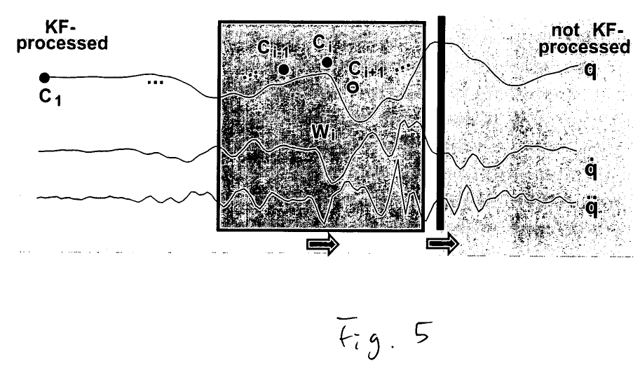

Note that B and accordingly B# are band-diagonal sparse matrices. This means that each control point in Equation 19 is determined by the section in \check{q} that corresponds to the nonzero entries of B^{#}. This locality suggests that the control points should be computed from the motion data within the window shown in FIG. 5, which moves along the time axis as the Kalman filter advances. Suppose c₁, c₂, . . . , cᵢ_{_{—}}₁ have already been computed. When the center of the window of width W is positioned over the control point cᵢ, we determine cᵢ using the portion of \check{q} that exists within the window. This scheme is equivalent to the global fitting described above if the window size is large enough. The plot of accuracy versus window size depends on the order and knot-interval of the B-spline curve. In our experiments, W=64 gave almost the same accuracy as the global fitting.

7. Discussion

In this section, we analyze our algorithm in comparison with previous approaches and manifest its limitations as well as its strengths. It will be helpful for us to better understand what type of motion this technique is suited for.

Statistical Inference vs. Derivative-Based Optimization.

One of the main differences of our algorithm compared to the previous methods is the statistical approach in dealing with the nonlinearity of constraints. While derivative-based optimization uses Jacobians or Hessians of the constraints and objective function, our statistical method approximates the nonlinear function by evaluating the function values on a set of samples, which can be viewed in some sense as statistical derivatives. Even though derivative-based approach theoretically has the same expressive power, in practice we found that statistical approach provides more flexibility to address stiff problems.

Local (Per-Frame) vs. Global Method.

Another key difference, which might be the most significant reason our method works fast, is that the method splits the given motion editing problem into per-frame pieces with post filtering, instead of casting it as one large optimization problem as in the previous methods. A limitation of our per-frame approach is that it can not make any dynamic anticipation on a large timescale. Therefore, the algorithm is not suited for editing a motion that requires global modification on the whole duration of the motion. For example, to generate the motion of punching an object with a dynamic constraint that the final speed of the fist should be considerably larger than that of the original motion, a large pull-back action is expected long before the arm makes the hit. However, our algorithm would attempt to modify the motion only in the neighborhood of the final frame. In fact, other optimization techniques that use local derivatives may have the potential to suffer this locality problem. In this work, the problem can be circumvented by providing a rough sketch of the desired motion as a new source motion. We call it a kinematic hint. Kinematic hints can be an effective means to produce the desired motion when our method is interactively used by an animator who has an intuitive idea of the form of the final motion.

Filter Tuning.

The filter parameters (V_{x,*} and N_{z} in the UKF, and the weight parameter W in the least-squares filter) significantly affect the filtering performance. Therefore, unless the parameter values are carefully chosen through consideration of the type of constraints and target motion, the filter may not work properly. For example, too large V_{x,*} may lead to filter divergence, and too small V_{x,*} may result in slow convergence. Choosing appropriate filter parameters required trial-and-error procedures at first, but soon we have found that the following guidelines work well in most examples: V_{x.pos} is typically chosen from the range 10⁻⁹˜10⁻¹⁰, and we use V_{x.vel}=αV_{x.pos} and V_{x.acc}=α²V_{x.pos} where α=10˜100. The values of N_{z} are set to zero in most cases. One exception to this rule is when the the current constraint goal is too far; in which case we initially set N_{z} to a small but nonzero value (e.g. 10⁻¹⁰) and then adaptively decrease them to zero. Finally, we found that the weight parameter W=diag[I, βI, β²I] best scales the relative influences of q, \dot{q}, and \ddot{q} when β≈0.1. In fact, all the examples presented in this invention is made based on this guideline.

Convergence Problem.

Because of the nonlinear iterative nature of the problem, convergence is an important issue. It is virtually impossible to characterize the analytical condition under which the repeated applications of the Kalman filter and least-squares filter converge. According to our experiments, when only kinematic constraints exist, the technique produces a convergent solution with one or at most two applications of the filter. On the other hand, when we edit a motion involving dynamic constraints, the effects of the Kalman filter on position, velocity, and acceleration are in part cancelled by the following least-squares filter. Especially when the target motion is highly dynamic (e.g. such motions as in [Liu and Popovic 2002; Fang and Pollard 2003] in which the velocity and acceleration can have severely undulating patterns), the cancellation effect of the two filters may become dominant, and our method may not able to find a convergent solution. However, it is worth noting that in most cases we could find the filter parameters and/or kinematic hints such that 3-5 filter applications attain a reasonable level of dynamic quality.

Dynamic Quality Reduction in the Final Filter Application.

While the resulting motion from the repeated filter applications possesses desired dynamic quality, the application of the last least-squares filter can ruin the kinematic constraints to a noticeable degree. In such a case, we run the Kalman filter with the dynamic constraints turned off, which produced kinematically accurate motion, potentially destroying the previously attained dynamic quality. According to the experiments, however, the dynamic quality reduction was not significant.

Per-Frame Constraints Generation.

The global method requires the animators to set only high level goals (such as a jumping height); the rest is generated by the algorithm. On the other hand, our per-frame algorithm requires the animators to supply kinematic and dynamic constraints for each frame (in the form of trajectory, etc.). For example, to make the character to kick a certain object, the animator has to construct the desired trajectory that passes the object by modifying the originally given foot trajectory. It is an extra burden for the animator compared to the global method. On the other hand, it can be viewed as a means to control the details of the (kicking) motion.

8. Results

Our motion editing system was implemented as a Maya® plug-in on a PC® with a Pentium®-4 2.53 GHz processor and a GeForce® 4 graphics board. All the motion sequences used were captured at 30 Hz. The human model had a total of 54 DOFs, including 6 DOFs for the root located at the pelvis. The root orientation and joint angles were all represented by quaternions.

Below, we refer to the filtering with only kinematic constraints as kinematic filtering and denote i consecutive applications of the filter by i(K), and we refer to the filtering with both applications of the filter by j(D). In the following experiments, we used the full set of DOFs in the kinematic filtering, but omitted several less influential joints (e.g. wrists, elbow, ankles, and neck) in the dynamic filtering (total 27-DOFs) to improve the performance.

This section reports the results of five experiments. The filter applications used and the resulting frame rates in these experiments are summarized in Table I. The decision on the number and types of the filter applications are up to the users. They can apply the filtering repeatedly until they find the result satisfactory, and also they can start by imposing kinematic hint for better performance.

| | | # frames/ | | average |
|---|---|---|---|---|
| motion | # frames | knot | # filtering operation | frame rate |
| dancing | 660 | | 1(K) | 150.0 |
| wide steps | 260 | 4 | 2(D) + 1(K) | 15.4 |
| golf swing | 216 | 2 | 1(K) + 3(D) + 1(K) | 15.2 |
| limbo walk | 260 | 4 | 1(K) + 2(D) + 1(K) | 13.7 |
| jump kick | 152 | 2 | 3(D) + 1(K) | 11.3 |

Dancing (On-Line Kinematic Retargeting).

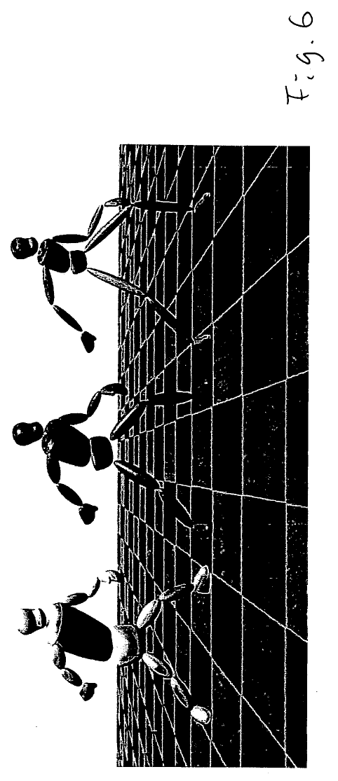

Referring to Animation 1A (FIG. 6), we retargeted the dancing motion of the middle character to the characters on the left (shorter limbs and longer torso) and right (longer limbs and shorter torso). The foot trajectories of the source character were used without scaling as the kinematic constraints of the target characters. The height differences were accounted for by raising or lowering the root of the source character by a constant amount. In this experiment, a single application of the Kalman filter (without the least-squares filter) generated the target motions without any artifacts. Animation 1B is the real-time screen capture during the production of Animation 1A. In other examples, which are not included in the specification, if the end-effector goal was too far or followed a severely non-smooth path, Kalman filtering alone could produce temporal artifacts. In such cases, application of the least-squares filter solved the problem, although it created a delay of about one second. In numerous experiments, the kinematic filtering worked stably and robustly.

Wide Steps.

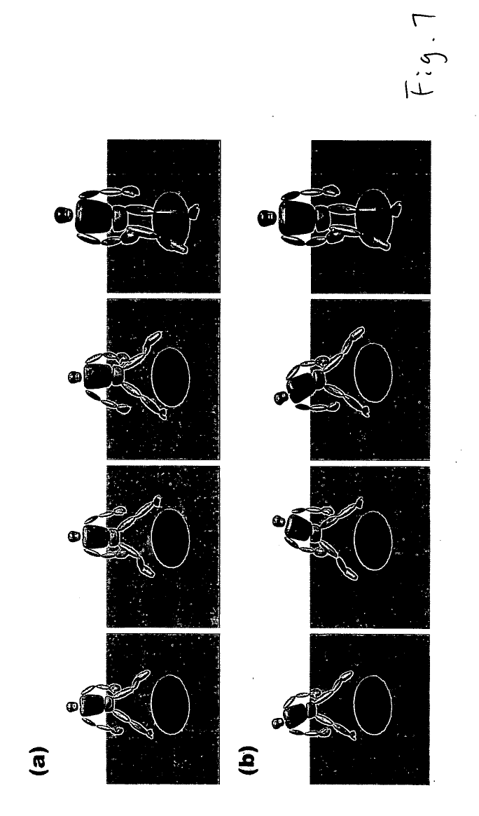

In this experiment, we considered the problem of converting the normal walking steps in Animation 2A into the sequence of wide steps taken to go over a long narrow puddle. The kinematic filtering produced the physically implausible result shown in Animation 2B (FIG. 7(a)). To make the motion physically plausible, we added a balance constraint, and applied dynamic filtering twice followed by a final kinematic filtering to impose the foot constraints (2(D)+1(K)); these calculations produced Animation 2C (FIG. 7(b)). In this animation, the character now sways his body to meet the balance constraints. The previous two results are compared in Animation 2D. Animation 2E is the real-time screen capture during the production of the above animations.

Golf Swing.

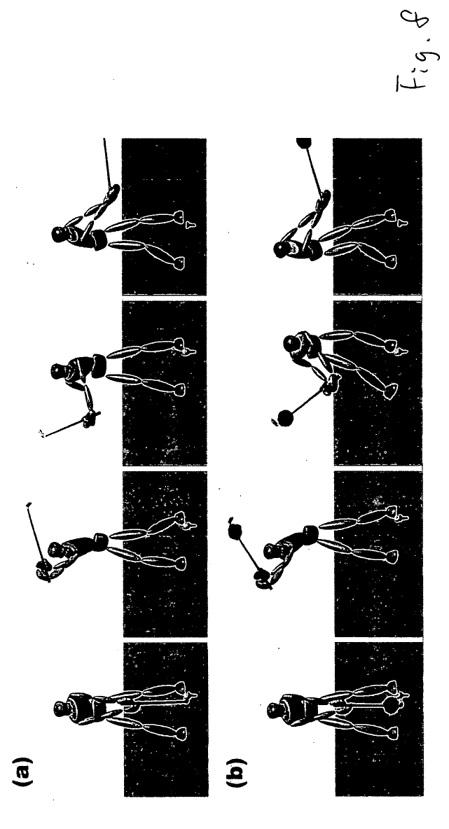

This experiment shows how our technique retargets the golf swing shown in Animation 3A (FIG. 8(a)) when a heavy rock (8 kg, which is ⅛ of the character's total mass) is attached to the head of the club. We imposed balance constraints, but did not impose torque constraints because simply raising the club immediately causes torque limit violations at the shoulder and elbow. To facilitate convergence, we provided a kinematic hint, which is actually one kinematic filtering 1(K), mainly consisting of the shift of the pelvis with both feet fixed (Animation 3B). 3(D)+1(K) filter applications onto the kinematic hint produced Animation 3C (FIG. 8(b)). In the resulting motion, the upper-body of the character makes a large movement to counterbalance the heavy club. The original and retargeted motions are compared in Animation 3D.

Limbo Walk.

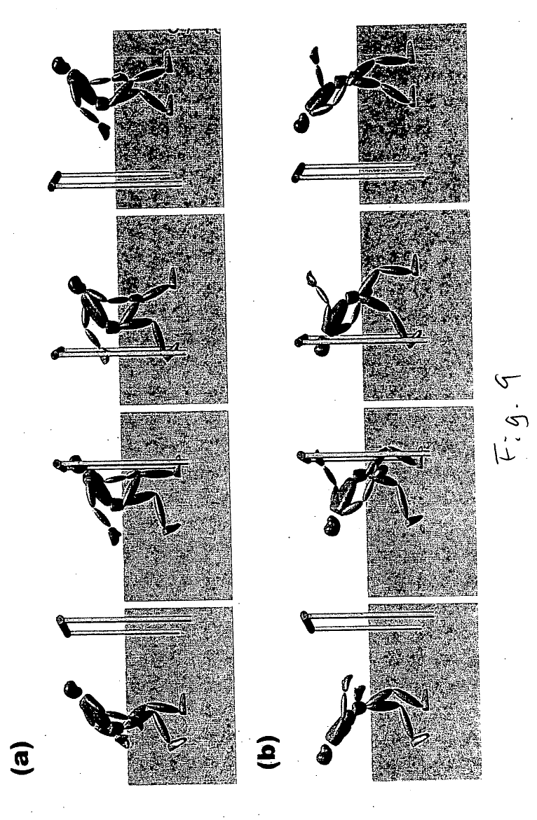

In this experiment the walking motion shown in Animation 2A is retargeted to a limbo walk (Animation 4A=Animation 2A). We placed a limbo bar at ⅘ of the height of the character. Balance constraints along with a (soft) kinematic constraint on the head height produced Animation 4B (FIG. 9(a)), which is obviously not a limbo motion. The height was lowered a few steps ahead. To fix the problem, we provided a kinematic hint. A further 2(D)+1(K) filter applications produced the realistic limbo walk shown in Animation 4C (FIG. 9(b)). In another experiment, we animated the limbo motion of a character whose torso was twice as heavy as that of the original character, and we imposed the torque limit constraint. In this setup, the character could not bend the torso to the same extent as in the original case; thus the kinematic constraint, which was the soft constraint, could not be satisfied (Animation 4D).

Jump Kick.

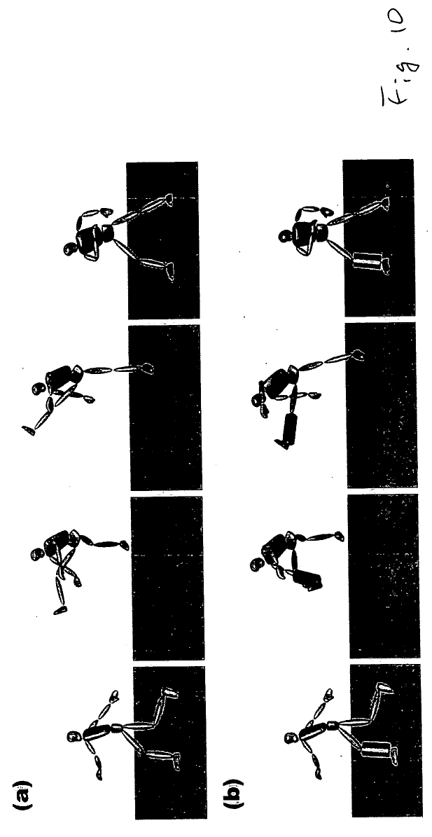

This experiment shows how our motion editing technique adjusts the jump kick motion shown in Animation 5A (FIG. 10(a)) to allow for the addition of a 10 kg sandbag to the right calf of the character. The motion consists of a supporting phase, a flight phase, and another supporting phase. We imposed balance and torque constraints along with foot position constraints during the supporting phases and torque and momentum constraints during the flight phase. Since the position of the landing foot at the end of the flight phase is affected by the attached weight, we adjusted the footprints to account for this. Without any kinematic hints, the algorithm produced a convergent result after 3(D)+1(K) filter applications. In the resulting motion, shown in Animation 5B, it is evident that the character cannot lift the weighted leg as high as the original character due to the torque constraints. An approach based on the muscle force model may generate a more plausible motion than clamping the joint torques. The momentum constraints make the upper body bend forward to compensate for the momentum change in the right leg (FIG. 10(b)).

9. Conclusion

In this invention we have presented a novel interactive motion editing technique for obtaining a physically plausible motion from a given captured or animated motion. To date, most methods for carrying out such motion retargeting have been formulated as a spacetime constraints problem. In contrast to these previous methods, our method is intrinsically a per-frame algorithm; once the kinematic and dynamic constraint goals are specified, the proposed algorithm functions as a filter that sequentially scans the input motion to produce a stream of output motion frames at a stable interactive rate.

The proposed method requires interactive tuning of the filter parameters to adapt it to the different motions. Several (consecutive) applications of the filter may be required to achieve the desired convergence or quality, because the filter works as an enhancement operator. Experiments on a large variety of motions revealed that, in most cases, 3-5 applications are sufficient to produce realistic motions.

The method works in a scalable fashion. It provides various ways to trade off run time and animator effort against motion quality: (1) Animators can interactively control the type and amount of kinematic and dynamic constraints to shape the desired motion. (2) Animators can control the number of times the filter is applied according to the final quality that is required. (3) Animators can avoid the potential problem of slow convergence by providing a kinematic hint. This work made an exciting step forward in the constraint-based motion editing. Now, physically plausible motions can be produced by filtering existing motions on a per-frame basis.

According to the invention, a method for editing motion of a character includes steps of a) providing an input motion (source character) of the character sequentially along with a set of kinematic and dynamic constraints, and the input motion is provided by a captured or animated motion; b) applying a series of plurality of unscented Kalman filters for solving the contraints; c) processing the output from the unscented Kalman filters with a least-squares filter for rectifying the output; and d) producing a stream of output motion (target character) frames at a stable interactive rate. The steps are applied to each frame of the input motion

The method may further include a step of controlling the behavior of the filters by tuning parameters according to different motions and a step of providing a rough sketch (kinematic hint) for the filters to produce a desired motion.

The Kalman filter includes per-frame Kalman filter. The least-squares filter is applied only to recently processed frames.

The method may further include a step of retargeting the motion of character kinematically.

The method may further include steps of a) providing motion parameters and desired constraints to the filters; b) resolving the kinematic and dynamic aspects of the source-to-target body differences; and c) creating variations from the original motion. The motion parameters include the position, velocity, and acceleration.

The Kalman filter handles the position, velocity, and acceleration as independent degrees of freedom. The number of Kalman filter is determined by the quality of output motion. The number of Kalman filter can one (1) for the kinematic constraints only.

The kinematic and dynamic constraints include kinematic constraints, balance constraints, and torque limit constraints, momentum constraints.

The character include a plurality of end-effectors to represent and control the spatial extension of the character, and the end-effectors are positioned by the kinematic constraints.

The kinematic constraints are represented by a component constraint function H_{K}, where H_{K} is formulated as H_{K}(q, \dot{q}, \ddot{q})=h_{fk}(q), where h_{fk}(q)=e is a forward kinematic equation, where e is a desired locations and q is a vector that completely describes the kinematic configuration of the character at a certain time.

The balance constraints is for the net moment of inertial forces and gravitational forces of all the body component at a zero moment point (ZMP) to be located inside the supporting area (S), where the supporting area is a convex hull containing all the ground contacts.

The moment of inertial forces and gravitational forces at the zero moment point is obtained by solving the equation for

$${P}_{zmp ,} {\sum }_{i} [ ( {r}_{i} - {P}_{zmp} ) \times \{ {m}_{i} ( {\ddot{r}}_{i} - g ) \} ] = 0 ,$$

where mᵢ and rᵢ are the mass and center of mass of the i-th segment of the body and g is the gravitation of gravity. The balance of the character is achieved by modifying the motion parameters including position, velocity, and acceleration such that the moment of inertial forces and gravitational forces at the zero moment point gets back to the area S.

The balance constraints are imposed by calculating the torque profile of the original motion and reducing the torque to the predetermined limit if the torque exceeds a predetermined limit.

The momentum constraints are imposed by making the change of the linear and angular momenta equal to the sums of the resultant forces and moments acting on the character. The momentum constraints are imposed only in flight phases, not in supporting phases.

The unscented Kalman filter uses a deterministic sampling method that approximates the posterior mean and covariance from the transformed results of a fixed number of samples.

The deterministic sampling method for a given nonlinear function h(x)=z defined for n-dimensional state vector x includes steps of: a) choosing 2n+1 sample points that convey the prior state distribution (mean and covariance of x); b) evaluating the nonlinear function h at these points; c) producing the transformed sample points; and d) approximating the posterior mean and covariance by calculating the weighted mean and covariance of the transformed sample points.

The Kalman filter includes a per-frame Kalman filter, and the least-squares filter rectified any corruption of the relationship among the independent variables; position, velocity, and acceleration. The least-squares filter smoothes out the jerkiness introduced by the per-time handling of the motion data.

While the invention has been shown and described with reference to different embodiments thereof, it will be appreciated by those skilled in the art that variations in form, detail, compositions and operation may be made without departing from the spirit and scope of the invention as defined by the accompanying claims.

### REFERENCES

CHOI, K. AND KO, H. 2000. On-line motion retargetting. Journal of Visualization and Computer Animation 11, 5, 223.235.
COHEN, M. F. 1992. Interactive spacetime constraint for animation. In Computer Graphics (Proceedings of ACM SIGGRAPH 92). 26,2. ACM, 293.302.
CRAIG, J. J. 1989. Introduction to Robotics. Addison-Wesley.
DASGUPTA, A. AND NAKAMURA, Y. 1999. Making feasible walking motion of humanoid robots from human motion capture data. In Proceedings of the IEEE ICRA. Vol. 2. 1044.1049.
FALOUTSOS, P., VAN DE PANNE, M., AND TERZOPOULOS, D. 2001. Composable controllers for physics-based character animation. In Proceedings of ACM SIGGRAPH 2001. Computer Graphics Proceedings. ACM, ACM Press/ACM SIGGRAPH, 251.260.
FANG, A. C. AND POLLARD, N. S. 2003. Efficient synthesis of physically valid human motion. ACM Transactions on Graphics 22, 3, 417.426.
GEETER, J. D., BRUSSEL, H. V., AND SCHUTTER, J. D. 1997. A smoothly constrained kalman filter. IEEE Transactions on Pattern Analysis and Machine Intelligence, 1171.1177.
GLEICHER, M. 1997. Motion editing with spacetime constraints. In Proceedings of the 1997 Symposium on Interactive 3D Graphics.
GLEICHER, M. 1998. Retargetting motion to new characters. In Proceedings of ACM SIGGRAPH 98. Computer Graphics Proceedings. ACM, ACM Press/ACM SIGGRAPH, 33.42.
GLEICHER, M. 2001. Comparing constraint-based motion editing methods. Graphical Models 63, 2, 107.134.
HODGINS, J. K. AND POLLARD, N. S. 1997. Adapting simulated behavior for new characters. In Proceedings of ACM SIGGRAPH 97. Computer Graphics Proceedings. ACM, ACM Press/ACM SIGGRAPH, 153.162.
HODGINS, J. K., WOOTEN, W. L., BROGAN, D. C., AND O'BRIEN, J. F. 1995. Animating human athletics. In Proceedings of ACM SIGGRAPH 95. Computer Graphics Proceedings. ACM, ACM Press/ACM SIGGRAPH, 71.78.
JULIER, S. J. AND UHLMANN, J. K. 1997. A new extension of the kalman filter to nonlinear systems. In Proceedings of AeroSense: The 11th International Symposium on Aerospace/Defense Sensing, Simulation and Controls.
KO, H. AND BADLER, N. I. 1996. Animating human locomotion in real-time using inverse dynamics, balance and comfort control. IEEE Computer Graphics and Applications 16, 2, 50.59.
KOMURA, T., SHINAGAWA, Y., AND KUNII, T. L. 1999. Calculation and visualization of the dynamic ability of the human body. Journal of Visualization and Computer Animation 10, 57.78.
LEE, J. AND SHIN, S. Y. 1999. A hierarchical approach to interactive motion editing for human-like figures. In Proceedings of ACM SIGGRAPH 99. Computer Graphics Proceedings. ACM, ACM Press/ACM SIGGRAPH, 39.48.
LEE, P., WEI, S., ZHAO, J., AND BADLER, N. I. 1990. Stregth guided motion. In Computer Graphics (Proceedings of ACM SIGGRAPH 90). 24,3. ACM, 253.262.
LIU, C. K. AND POPOVIC, Z. 2002. Synthesis of complex dynamic character motion from simple animations. ACM Transactions on Graphics 21, 3, 408.416.
LIU, Z., GORTLER, S. J., AND COHEN, M. F. 1994. Hierarchical spacetime control. In Proceedings of ACM SIGGRAPH 94. Computer Graphics Proceedings. ACM, ACM Press/ACM SIGGRAPH, 35.42.
MAYBECK, P. S. 1979. Stochastic Models, Estimation, and Control. Vol. 1. Academic Press, Inc.
OSHITA, M. AND MAKINOUCHI, A. 2001. A dynamic motion control technique for human-like articulated figures. In Proceedings of Eurographics 2001.
POLLARD, N. S. AND BEHMARAM-MOSAVAT, F. 2000. Force-based motion editing for locomotion tasks. In Proceedings of the IEEE ICRA. Vol. 1. 663.669.
POPOVIC, Z. AND WITKIN, A. 1999. Physically based motion transformation. In Proceedings of ACM SIGGRAPH 99. Computer Graphics Proceedings. ACM, ACM Press/ACM SIGGRAPH, 11.20.
ROSE, C., GUENTER, B., BODENHEIMER, B., AND COHEN, M. F. 1996. Efficient generation of motion transitions using spacetime constraints. In Proceedings of ACM SIGGRAPH 96. Computer Graphics Proceedings. ACM, ACM Press/ACM SIGGRAPH, 147.154.
SHABANA, A. A. 1994. Computational Dynamics. John Wiley & Sons, Inc. SHIN, H. J., KOVAR, L., AND GLEICHER, M. 2003. Physical touch-up of human motions. In Proceedings of Pacific Graphics 2003.
SHIN, H. J., LEE, J., SHIN, S. Y., AND GLEICHER, M. 2001. Computer puppetry: An importance-based approach. ACM Transactions on Graphics 20, 2, 67.94.
SIMON, D. AND CHIA, T. 2002. Kalman filtering with state equality constraints. IEEE Transactions on Aerospace and Electronic Systems 39, 128.136.
SUGIHARA, T., NAKAMURA, Y., AND INOUE, H. 2002. Realtime humanoid motion generation through zmp manipulation based on inverted pendulum control. In Proceedings of the IEEE ICRA. Vol. 2. 1404.1409.
TAK, S., SONG, O., AND KO, H. 2000. Motion balance filtering. Computer Graphics Forum (Eurographics 2000) 19, 3, 437.446.
TAK, S., SONG, O., AND KO, H. 2002. Spacetime sweeping: An interactive dynamic constraints solver. In Proceedings of Computer Animation 2002. 261.270.
VAN DE PANNE, M. 1996. Parameterized gait synthesis. IEEE Computer Graphics and Applications 16, 2, 40.49.
VAN DER MERWE, R. AND WAN, E. A. 2001. The squre-root unscented kalman filter for state and parameter estimation. In Proceedings of International Conference on Acoustics, Speech, and Signal Processing.
VUKOBRATOVIC, M., BOROVAC, B., SURLA, D., AND STOKI C, D. 1990. Biped Locomotion: Dynamics, Stability, Control and Application. Springer Verlag.
WAN, E. A. AND VAN DER MERWE, R. 2000. The unscented kalman filter for nonlinear estimation. In Proceedings of Symposium 2000 on Adaptive Systems for Signal Processing, Communication and Control.
WAN, E. A. AND VAN DER MERWE, R. 2001. Kalman Filtering and Neural Networks (Chapter 7. The Unscented Kalman Filter). John Wiley & Sons.
WELCH, G. AND BISHOP, G. 2001. An introduction to the kalman filter. ACM SIGGRAPH 2001 Course Notes.
WINTER, D. A. 1990. Biomechanics and Motor Control of Human Movement. Wiley, New York.
WITKIN, A. AND KASS, M. 1988. Spacetime constraints. In Computer Graphics (Proceedings of ACM SIGGRAPH 88). 22,4. ACM, 159.168.
YAMANE, K. AND NAKAMURA, Y. 2000. Dynamics filter: Concept and implementation of online motion generator for human figures. In Proceedings of the IEEE ICRA. Vol. 1. 688.694.
YAMANE, K. AND NAKAMURA, Y. 2003. Dynamics filter—concept and implementation of online motion generator for human figures. IEEE Transactions on Robotics and Automation 19, 3, 421.432.
ZORDAN, V. B. AND HODGINS, J. K. 2002. Motion capture-driven simulations that hit and react. In 2002 ACM SIGGRAPH Symposium on Computer Animation. 89.96.

What is claimed is:

1. A method for editing motion of a character comprising steps of:
a) providing an input motion (source character) of the character sequentially along with a set of kinematic and dynamic constraints, wherein the input motion is provided by a captured or animated motion;
b) applying a series of plurality of unscented Kalman filters for solving the contraints;
c) processing the output from the unscented Kalman filters with a least-squares filter for rectifying the output; and
d) producing a stream of output motion (target character) frames at a stable interactive rate,
wherein the steps are applied to each frame of the input motion

2. The method of claim 1, further comprising a step of controlling the behavior of the filters by tuning parameters according to different motions.

3. The method of claim 1, further comprising a step of providing a rough sketch (kinematic hint) for the filters to produce a desired motion.

4. The method of claim 1, wherein the Kalman filter comprises per-frame Kalman filter.

5. The method of claim 4, wherein the least-squares filter is applied only to recently processed frames.

6. The method of claim 1, further comprising a step of retargeting the motion of character kinematically.

7. The method of claim 1, further comprising steps of:
a) providing motion parameters and desired constraints to the filters;
b) resolving the kinematic and dynamic aspects of the source-to-target body differences; and
c) creating variations from the original motion.

8. The method of claim 7, wherein the motion parameters comprise the position, velocity, and acceleration.

9. The method of claim 1, wherein the Kalman filter handles the position, velocity, and acceleration as independent degrees of freedom.

10. The method of claim 1, wherein the number of Kalman filter is determined by the quality of output motion.

11. The method of claim 1, wherein the number of Kalman filter is one (1) for the kinematic constraints only.

12. The method of claim 1, wherein the kinematic and dynamic constraints comprise kinematic constraints, balance constraints, and torque limit constraints, momentum constraints.

13. The method of claim 12, wherein the character comprise a plurality of end-effectors to represent and control the spatial extension of the character, wherein the end-effectors are positioned by the kinematic constraints.

14. The method of claim 13, wherein the kinematic constraints are represented by a component constraint function H_{K}, wherein H_{K} is formulated as
H_{K}(q, \dot{q}, \ddot{q})=h_{fk}(q),
where h_{fk}(q)=e is a forward kinematic equation, where e is a desired locations and q is a vector that completely describes the kinematic configuration of the character at a certain time.

15. The method of claim 12, wherein the balance constraints is for the net moment of inertial forces and gravitational forces of all the body component at a zero moment point (ZMP) to be located inside the supporting area (S), wherein the supporting area is a convex hull containing all the ground contacts.

16. The method of claim 15, wherein the moment of inertial forces and gravitational forces at the zero moment point is obtained by solving the equation for P_{zmp},
$${P}_{zmp ,} {\sum }_{i} [ ( {r}_{i} - {P}_{zmp} ) \times \{ {m}_{i} ( {\ddot{r}}_{i} - g ) \} ] = 0 ,$$
where mᵢ and rᵢ are the mass and center of mass of the i-th segment of the body and g is the gravitation of gravity.

17. The method of claim 16, wherein the balance of the character is achieved by modifying the motion parameters including position, velocity, and acceleration such that the moment of inertial forces and gravitational forces at the zero moment point gets back to the area S.

18. The method of claim 12, wherein the balance constraints are imposed by calculating the torque profile of the original motion and reducing the torque to the predetermined limit if the torque exceeds a predetermined limit.

19. The method of claim 12, wherein the momentum constraints are imposed by making the change of the linear and angular momenta equal to the sums of the resultant forces and moments acting on the character.

20. The method of claim 19, wherein the momentum constraints are imposed only in flight phases, not in supporting phases.

21. The method of claim 1, wherein the unscented Kalman filter uses a deterministic sampling method that approximates the posterior mean and covariance from the transformed results of a fixed number of samples.

22. The method of claim 21, wherein the deterministic sampling method for a given nonlinear function h(x)=z defined for n-dimensional state vector x comprises steps of:
a) choosing 2n+1 sample points that convey the prior state distribution (mean and covariance of x);
b) evaluating the nonlinear function h at these points;
c) producing the transformed sample points; and
d) approximating the posterior mean and covariance by calculating the weighted mean and covariance of the transformed sample points.

23. The method of claim 1, wherein the Kalman filter comprises a per-frame Kalman filter, wherein the least-squares filter rectified any corruption of the relationship among the independent variables; position, velocity, and acceleration, wherein the least-squares filter smoothes out the jerkiness introduced by the per-time handling of the motion data.
